(19) United States
(12) Patent Application Publication
(10) Pub. No.: US 2003/0180470 A1
(43) Pub. Date: Sep. 25, 2003

(54) A Curtain coating method for making a photographic light-sensitive material

(75) Inventors: Kazuhiro Oki, Kanagawa (JP); Yoshinobu Katagiri, Kanagawa (JP); Yasushi Suga, Kanagawa (JP)

Correspondence Address: SUGHRUE MION, PLLC, 2100 Pennsylvania Avenue, NW, Washington, DC, 20037-3213, US

(73) Assignee: FUJI PHOTO FILM CO., LTD.

(21) Appl. No.: 10/294,570

(22) Filed: Nov. 15, 2002

Related U.S. Application Data
(62) Division of application No. 08/947,898, filed on Oct. 9, 1997, now abandoned.

(30) Foreign Application Priority Data
Oct. 9, 1996 (JP) HEI. 8-268772
Oct. 15, 1996 (JP) HEI. 8-272207

(51) Int. Cl. B05D 1/30

(52) U.S. Cl. 427/420; 427/458

(57) ABSTRACT

A curtain coating method which enables the formation of a uniform curtain of coating solution without accompanied by the sagging phenomenon in a range of high flowing-down rates of a coating solution per unit length in curtain breadth, thereby elevating the upper limit of coating speed, is disclosed. In this method, a coating solution as a freely falling curtain is made to impinge on the surface of a continuously moving web, and thereby the coating solution is coated on the web. Therein, the curtain of the coating solution is controlled so that the flowing-down rate thereof per unit length in curtain breadth is from 2.5 to 10 cc/cm/sec, and the web surface to be coated with the coating solution is controlled so as to have a temperature between 22° to 55° C. A curtain coating method which can prevent the air entrainment phenomenon from occurring at the start in the coating operation and enables the formation of uniform coating is also disclosed.

### FIELD OF THE INVENTION

The present invention relates to a method of producing a photographic light-sensitive material, particularly a photographic film or photographic printing paper, wherein coating solutions, such as photographic emulsions, are applied uniformly to the surface of a continuously moving objects to be coated (called a web hereinafter) in accordance with a curtain coating method.

The present invention further relates to a curtain coating apparatus and, more particularly, to a curtain coating apparatus used for coating a liquid coating composition (called “a coating solution” hereinafter) on a web in the production of photographic films, photographic printing papers, magnetic recording tapes, adhesive tapes, pressure-sensitive recording papers, offset plate materials, batteries and the like.

### BACKGROUND OF THE INVENTION

A curtain coating method is known as a representative of the methods in which a curtain-form coating solution which freely falls from a coating solution hopper is impinged on the surface of a continuously moving web, and thereby the web surface is applied with the coating solution.

In the curtain coating method, one or at least two kinds of coating solutions are formed into a freely falling curtain, and this curtain is made to impinge on a web surface to be coated therewith to form a coated film on the web surface.

The curtain coating techniques have so far been applied in the production of photographic films, photographic printing papers or the like, and the basic arts of curtain coating are described, e.g., in U.S. Pat. No. 3,508,947 and U.S. Pat. No. 3,632,374 which correspond to JP-B-49-24133 and JP-B-49-35447 respectively (The term “JP-B” as used herein means an “examined Japanese patent publication”).

Further, S. F. Kistler discloses a theory of curtain coating in “AlChE Winter National Meeting” (1982), and describes the following three phenomena which predominantly determine the coating rate in the curtain coating method:

(1) the phenomenon that fine bubbles are entrained in a gap between a web and a coating solution (This phenomenon is called “the air entrainment phenomenon” hereinafter),

(2) the phenomenon that a foot-like cross-sectional shape of the impingement zone can develop a pronounced heel that can give rise to coating nonuniformity. (This phenomenon is called “the heel phenomenon” hereinafter, and it occurs in a case where a coating solution is made to flow down at a high flow rate), and

(3) the phenomenon that a coating solution bounds at the web surface without adhering thereto (This phenomenon is called “the sagging phenomenon” hereinafter, and it occurs in the same case as the phenomenon (2), namely a case where a coating solution is made to flow down at a high flow rate).

As for attempts to elevate the upper limit of coating speed in this curtain coating method, there is disclosed the means of inhibiting “the air entrainment phenomenon”, e.g., by applying an electrostatic field between a web and a coating solution to heighten the adhesiveness of the coating solution (JP-A-62-197176). (The term “JP-A” as used herein means an “unexamined published Japanese patent application”).

In recent years, however, the coating operation has been performed at a high speed of 250 m/min or above and the flowing-down rate of a curtain of coating solution has also been increased. As a result thereof, the retardation of coating Speed due to “the sagging phenomenon” has come to a greater problem than the retardation caused by the aforementioned “air entrainment phenomenon”.

As a measure to solve such a problem, there can be adopted the method of inhibiting “the heel phenomenon” by controlling the shearing viscosity between the upper and lower layers of a curtain of coating solution (JP-A-1-131549).

In the slide bead coating, on the other hand, the heat treatment of a substrate surface solves the troubles produced at the beginning of coating to enable high-speed coating and thin-layer coating, and the art thereof is disclosed by the present applicants in JP-A-61-278848.

However, the art described in the above-cited reference, JP-A-61-278848, relates to the coating stability in the slide bead coating wherein, although the coating limits depend on the air entrainment phenomenon, the flow rate of a coating solution has a slight influence upon the coating limits. Such being the case, no examination into a subject of the present invention, or inhibition of the heel phenomenon and the sagging phenomenon which are the phenomena characteristic of curtain coating, has been made yet.

In such a curtain coating method, on the other hand, it is important to spread coating solution(s) in a uniform thickness over the web surface at the start in the coating operation (hereinafter called “start-up process”) from the viewpoint of preventing the products including defects and so on.

Such being the case, U.S. Pat. No. 3,508,947 discloses the arrangement of a pivoted or slidably mounted deflector in the free falling curtain. Before the stable curtain of a coating solution fed in a desired flow rate, the deflector is arranged so as to intercept the curtain, and direct it into a tray. After start-up conditions are satisfied, the deflector is moved to its inoperative position where it remains until the coating operation is stopped, thereby effecting the transfer of the curtain onto the web surface.

We have found that excess accumulation of coating liquids on the web during curtain coating start-up is caused by the falling curtain impinging onto a slow moving curtain deflector, as well as the inadequate design and orientation of the deflector. In addition, it was found that the accumulation of coating liquids or “puddles” on the deflector was increased upstream of the falling curtain during retraction of the deflector. This together with the inertia of the accumulated liquid as the deflector was retracted beneath it, resulted in spill-off of excessive coating liquids on the web. All known curtain coating machines incorporating start-up devices such as a planar curtain deflector are attended by serious disadvantages and therefore are unsatisfactory for making acceptable coating starts.

As a means to dissolve the foregoing disadvantage, U.S. Pat. No. 4,851,268 discloses the method in which a catch pan device having a plurality of spaced lips at the extreme end is retracted through the falling curtain at a speed of from 50 to 200 cm/sec. On the other hand, JP-A-3-94863 disclosed the method in which the coating is started by moving a catch pan device back and forth at a speed of from 1 to 100 cm/sec.

However, in a case where the coating on a web which is moving at a high speed of 200 m/min or more is started by the removal of the catch pan device from the falling curtain, as far as only the motion speed of the catch pan device is controlled as disclosed in U.S. Pat. No. 4,851,268 and JP-A-3-94863, bubbles are caught up in the coating beads at the time when the curtain falls upon the web surface. Consequently, it has turned out that uniform coating cannot be achieved since bubbles are intermittently caught up into the coated liquid from immediately after the start-up, namely the so-called “air entrainment phenomenon” occurs.

### SUMMARY OF THE INVENTION

Therefore, an object of the present invention is to provide a curtain coating method which enables the formation of a uniform curtain of coating solution without accompanied by the sagging phenomenon under a condition that the flowing-down rate of the coating solution per unit length in curtain breadth is in a high rate range of 2.5 to 10 cc/cm/sec, thereby elevating the upper limits of coating speed.

Another object of the present invention is to provide a curtain coating method which enables the start in the formation of uniform coating without attended by the generation of the so-called “air entrainment phenomenon”.

As a result of our intensive study, it has been found that a uniform curtain of coating solution can be formed without accompanied by the sagging phenomenon and the upper limit of coating speed can be elevated when the curtain coating in the particular flow rate range is carried out under conditions specified by the present invention.

More specifically, the object of the present invention is achieved by a curtain coating method used for producing photographic light-sensitive materials, characterized in that the coating solution is coated so as to have a flowing-down rate per unit length in curtain breadth between 2.5 and 10 cc/cm/sec and the surface temperature of the moving web is controlled to be from 22° to 55° C.

In a preferred embodiment of the present invention, electrostatic charge is applied to the web surface before or during the foregoing curtain coating step employed for the production of a photographic light-sensitive material.

From a viewpoint of elevating the upper limit of coating speed, the more desirable result is obtained when the web surface has a higher temperature. In the production of photographic light-sensitive materials, however, it is generally necessary for the coated film to be gelled by the cooling just after coating. Owing to this restriction, the choice of a too high temperature causes a poor gelling of the coated film. Thus, the temperature range specified above seems to be optimum in the foregoing range of the flowing-down rate of a coating solution; as a result, the sagging phenomenon appears to be effectively prevented from occurring.

Further, the web surface is controlled so as to have an electric potential between 0.1 and 0.8 KV during the coating step by applying electrostatic charge thereto; as a result, the adhesiveness of a coating solution to the web surface is improved by the electrostatic force of attraction between them on which the electrostatic filed is acting. Thus, the stabilized coating becomes possible.

Further, the present method which enables the achievement of the aforementioned another object is characterized in that; in a curtain coating method, the curtain coating process is started under a condition that the web surface to be coated bears electric charge and at least either the coating hopper or a deflector, which is arranged so as to cross a falling course of the curtain before starting the curtain coating, is moved at a relative speed of from 20 to 350 mm/sec to restart the deflector through the curtain.

In the present method, the foregoing electrostatic charge is applied to the web surface by carrying out a corona discharge treatment just before starting coating operation, and it can produce a favorable effect to continue the application of electrostatic charge to the web surface after starting the curtain coating also.

In accordance with the present invention, the formation of uniform coating free from the air entrainment phenomenon can be started by controlling the motions of a coating hopper and a deflector so as to have their relative speed between 20 to 350 mm/sec at the time when the coating operation is started under a condition that the web surface to be coated bears electrostatic charge and the deflector is retracted through the curtain by moving at least either the coating hopper or the deflector.

### BRIEF DESCRIPTION OF THE DRAWINGS

FIG. 1 is a graph showing the relationship between the web surface temperature and the upper limit of coating speed under a definite coating flow rate in the curtain coating method.

FIG. 2 is a schematic view showing the main parts in an embodiment of the present curtain coating method.

FIG. 3 is a vertical sectional view of the principal constitutional units of a slide hopper type curtain coating apparatus to which the present curtain coating method using a deflector is applied, wherein the way of starting the coating operation in accordance with an embodiment of the present invention is illustrated.

FIG. 4 is a vertical sectional view of the principal constitutional units of a slide hopper type curtain coating apparatus to which the present curtain coating method using a deflector is applied, wherein the way of starting the coating operation in accordance with another embodiment of the present invention is illustrated.

FIG. 5 is a vertical sectional view of the principal constitutional elements of a slide hopper type curtain coating apparatus using a deflector, wherein the way of charging the web surface for coating in accordance with an embodiment of the present invention is illustrated.

### DETAILED DESCRIPTION OF THE INVENTION

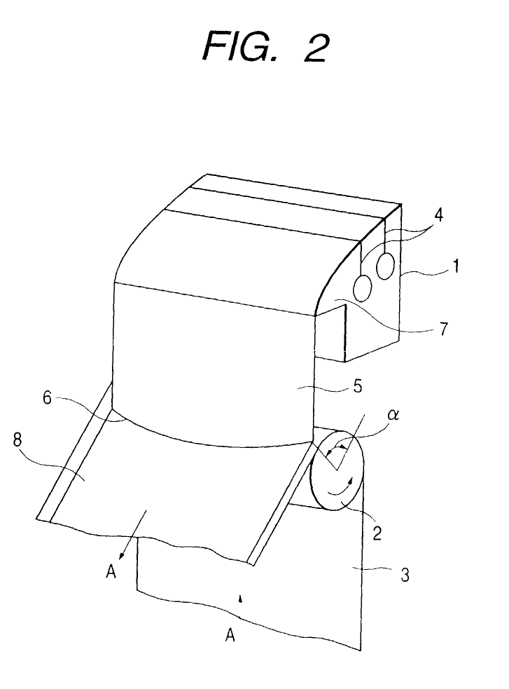

The coating method of the present invention is illustrated below by reference to the embodiment shown in FIG. 2.

The coating head 1 shown in FIG. 2 has a plurality of slits 4 which are connected to their respective liquid reservoirs, and the coating solution fed from a slit 4 slides on the slide hopper 7 and falls to form a curtain 5 of coating solution.

The curtain 5 falls and impinges at a line 6 on the surface of a web 3, which is moving at a high speed (in the direction of an arrow A) as it is supported by the backup roller 2, thereby forming the coated film 8.

The distance between the impinging position 6 of the curtain 5 and the lip part (end part) of the slide hopper 7 can be adjusted to, e.g., the order of 100 mm, and the angle α made by the web 3 with the horizontal line at the impinging position of the curtain 5, though it does not have any particular restriction, can be adjusted to, e.g., about 60°.

The present invention can be embodied using the apparatus having the foregoing construction. More specifically, as shown in FIG. 2, a coating solution is formed into a free-falling curtain 5 and made to impinge on the surface of a web 3 which is moving continuously, and thereby the web is coated with the coating solution. In this operation, the flowing-down rate per unit length in curtain breadth is chosen from the range of 2.5 to 10 cc/cm/sec and the surface temperature of the moving web is controlled to be from 22° to 55° C.

In a preferred embodiment of the present invention, electrostatic charge is applied to the surface of a web 3 before or during the coating.

By performing the curtain coating under the aforementioned conditions, a uniformly coated film can be formed without causing the sagging phenomenon and the upper speed of coating speed can be increased.

In addition, by controlling so that the web surface potential be within the range of 0.1 and 0.8 KV during the coating step by applying electrostatic charge to the web surface, the electrostatic force of attraction is generated between the coating solution and the web on which the electrostatic filed is acting; as a result, the adhesiveness of a coating solution to the web surface is heightened. Thus, it becomes possible to effect more stabilized coating.

With respect to the method of adjusting the surface temperature of the web 3 so that it is in the range specified above, the web may undergo a heat treatment before the coating, or the surface temperature of the web 3 may be controlled through the adjustment of the surrounding temperature.

For the foregoing heat treatment of the web 3, various heating methods as described below can be adopted. For instance, a heating zone is properly provided prior to the coating zone in the course of conveying a web, and the web surface is heated therein by blowing a hot air heated to a prescribed temperature against the moving web 3. In another method, an infrared heating zone or a microwave oven is provided, and the web 3 is passed therethrough to undergo radiant or dielectric heating. In a further method, a carrier roller contact with the web is heated by passing therethrough a hot air or steam, and the web is heated by the heat transmitted from the carrier roller. These methods may be adopted independently or in combination.

As for the method of applying electrostatic charge to the surface of the web 3, there can be adopted a method in which a DC high voltage is applied to discharge electrodes to generate corona discharge, and thereby a monopolar charge is given to the web surface, or a method in which a DC voltage is applied to the aforementioned backup roller 2. In addition to these methods, various other methods can be adopted in the present invention.

The present curtain coating method using a deflector can be applied to every curtain coating apparatus. The embodiments of the present invention are illustrated below, using for an example a curtain coating apparatus of the slide hopper type.

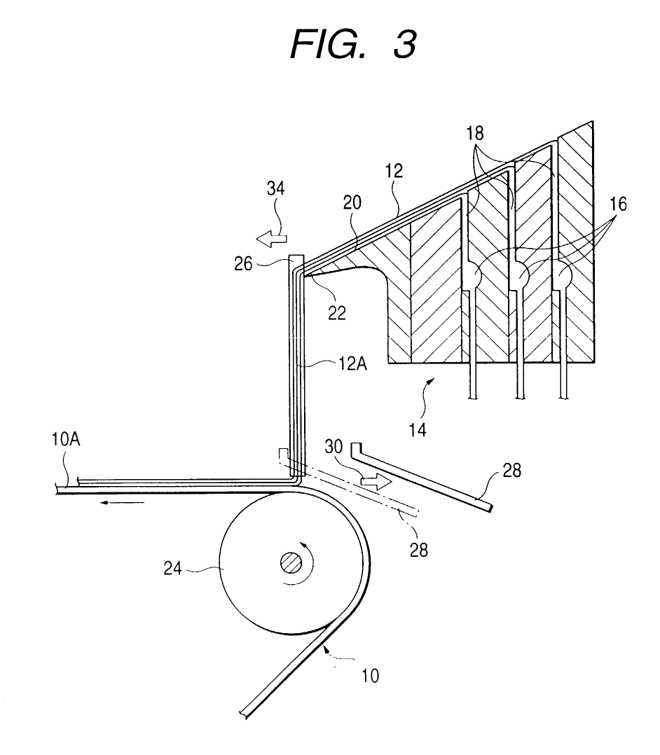

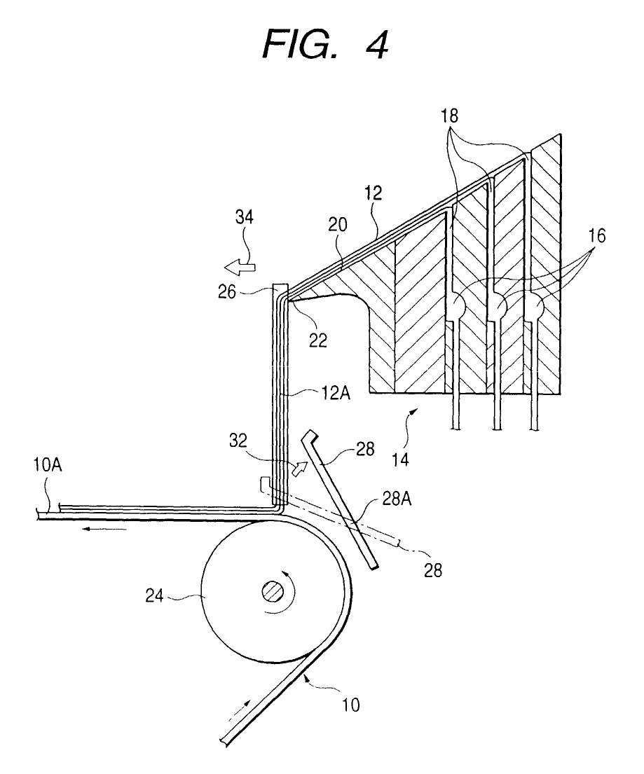

Each of FIGS. 3 and 4 is a vertical sectional view of the principal constitutional units of a slide hopper type curtain coating apparatus to which the present curtain coating method is applied, wherein the way of starting up the coating operation in accordance with an embodiment of the present invention is illustrated.

Specifically, coating solutions 12 to be coated on the surface of a web 10 are fed at a constant flow rate from their respective coating solution tanks (not shown in the figure) to manifolds 16 placed in a slide hopper 14. The coating solutions 12 fed to the manifolds 16 are made to flow so as to spread in the intended coating breadth, and then extruded through slits 18 onto a downwardly sloping slide plane 20 as the upper surface of a slide hopper 14. The coating solutions 12 extruded onto the slide plane 20 flow down on the slide plane 20, and freely fall in the form of curtain 12A from the extreme end 22 of a lip as the lower edge of the slide plane 20. In order to easily achieve the free falling of the coating solutions 12 by the force of gravity, the extreme end 22 of the lip is shaped so as to have an acute triangular cross section. The curtain 12A falling from the extreme end 22 of the lip impinges on the surface of a web 10 which is spread on a backup roller 24 so as to move around the backup roller in the course of its travel, and thereby the web surface for 10A is covered with the coating solution film to form a coating.

In addition, a pair of edge guides 26 and 26 which each extend from the vicinity of the extreme end 22 of the lip to the vicinity of the position in which the curtain 12A impinges on the web surface 10A are arranged respectively at both edges of the curtain 12A, thereby performing the breadth control of the curtain.

Further, a deflector 28 which is provided with a barrage by shaping the extreme end thereof into the capital L is arranged on a falling course of the curtain 12A. Before the coating operation, as drawn with an alternate long and two short dashes line, the deflector 28 is arranged so as to cross the falling course of the curtain 12A. At the time of starting the coating operation, as shown with a continuous line, the deflector is detracted through the falling course of the curtain 12A. The barrage is formed at the extreme end of the deflector 28 from a reason that the generation of the heel phenomena which is described above as a problem in the prior art can be prevented by retracting the deflector 28 through the curtain 12A. In order to take the deflector 28 through the curtain, at least either the slide hopper 14 or the deflector 28 is moved. For instance, the movement of the deflector 28 is carried out by sliding the deflector, as shown in FIG. 3, or turning the deflector in an arrow direction 32 on its fulcrum 28A, as shown in FIG. 4, from the position indicated by the alternate long and two short dashes line to the position indicated by the continuous line. Herein, the center of the turning motion may not be the fulcrum 28A, but it can be an imaginary point which is off the deflector 28. Further, the deflector 28 may be a flat plate, or it may be a plate curved in the form of circular arc. On the other hand, the slide hopper is moved, as shown in FIG. 3, in an arrow direction 34 which is the direction opposite to the sliding direction of the deflector 28 (the arrow direction 30), or the movement of the slide hopper in the arrow direction 34 is, as shown in FIG. 4, synchronized to the turning of the deflector. In moving at least either the slide hopper 14 or the deflector 38, it is required to control the relative motion speed of them to the range of 20 to 350 mm/sec. Additionally, the foregoing relative speed has the same meaning as the relative speed defined using the curtain 12A instead of the slide hopper 14.

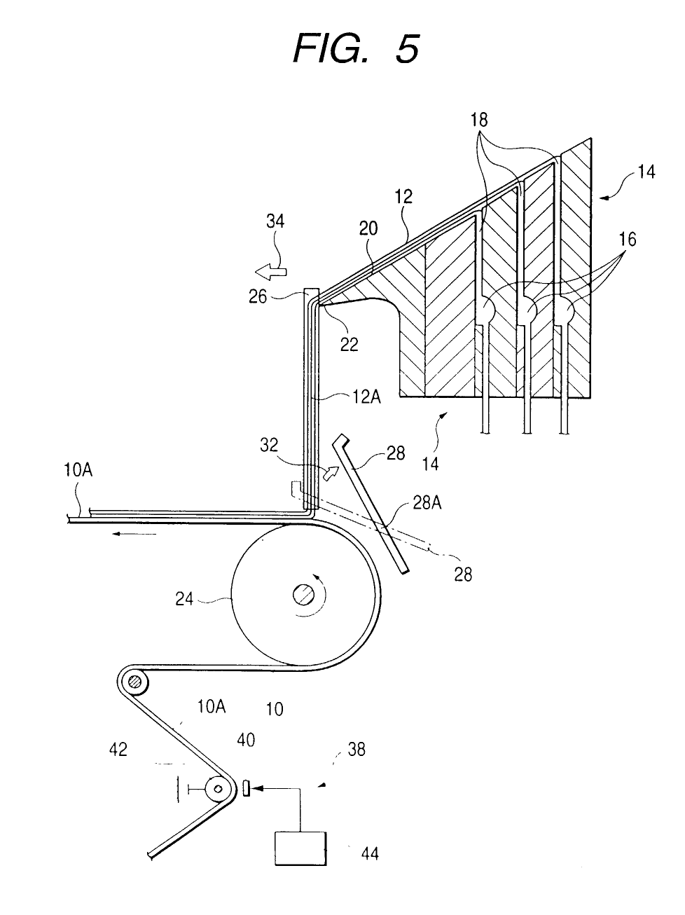

FIG. 5 is a vertical sectional view of the principal constitutional elements of a slide hopper type curtain coating apparatus, wherein the way of charging the web surface 10A in accordance with an embodiment of the present invention is illustrated. This figure shows an example of the way to apply monopolar electrostatic charge to the web surface 10A by subjecting the web surface 10A to a corona discharge treatment immediately before the impingement of the curtain 12A on the web surface.

More specifically, a corona discharge device 38 is arranged on a travelling route of the web 10, and that on just this side of the backup roller 24. This corona discharge device 38 is constituted of an electrode 40 arranged on the coating side of the web surface 10A, a charging roller 42 arranged on the other side of the web and opposite to the electrode 40, and a high voltage generating device 44 for generating corona discharge by applying a high voltage between the electrode 40 and the discharge roller 42. By this corona discharge, either plus or minus electrostatic charge is given to the web surface to generate an electric potential on the web surface.

In accordance with the embodiment of the present invention, the motions of the coating hopper 14 and the deflector 28 are controlled so as to have their relative speed between 20 to 350 mm/sec at the time when the coating operation is started under a condition that a electrostatic potential is applied to the web surface and the deflector 28 is detracted through the curtain 12A by moving at least either the coating hopper or the deflector, thereby achieving the start-up in the formation of uniform coating without attended by generation of the air entrainment phenomenon.

The coating solutions 12 used in the present invention can include various liquid compositions depending on the end use purpose. Specifically, those liquid compositions include the coating solutions for light-sensitive emulsion layers, subbing layers, protective layers, backing layers and so on when the present invention is applied to the production of a photographic light-sensitive material. In another application of the present method, e.g., to the production of a magnetic recording material, the coating solutions used in the present invention include those for magnetic layers, subbing layers, lubricant layers, protective layers, backing layers and so on. In still another application of the present invention, e.g., to an information recording paper, the liquid compositions usable in the present invention include coating solutions for layers containing microcapsules as a main component and layers containing coloring materials as a main component. In further application of the present invention, e.g., to materials for graphic arts, the liquid composition usable in the present invention include photosensitive layers, resin layers, matt layers and so on.

The web 10 used in the present invention includes a paper web, a plastic film web, a metal web, a resin-coated paper web and a synthetic paper web. As examples of a material for a plastic film web, mention may be made of a polyolefin such as polyethylene or polypropylene, a vinyl polymer such as polyvinyl acetate, polyvinyl chloride or polystyrene, a polyamide such as 6,6-nylon or 6-nylon, a polyester such as polyethylene terephthalate or polyethylene-2,6-naphthalate, a polycarbonate, and a cellulose acetate such as cellulose triacetate or cellulose diacetate. As for the resin used for making a resin-coated paper, polyolefins including polyethylene are typical examples thereof, but any other resins may be used therefor. As for the metal web, an aluminum web is an example thereof.

The advantages of the present invention will become more clearer by Examples according to embodiments of the present coating method.

### EXAMPLES 1 TO 17 AND COMPARATIVE EXAMPLES 1 TO 15

Each sample of multilayer color photographic paper having the following layer structure was prepared by coating various photographic constituent layers on a polyethylene-laminated baryta paper having a subbing layer in accordance with a curtain coating method. The coating operations in Examples according to the present invention were performed using the apparatus as shown in FIG. 2.

[Layer Structure]

The composition of each constituent layer is described below. Each figure on the right side designates the coverage (g/m²) of the ingredient corresponding thereto. As for the silver halide emulsion, the figure represents the coverage based on silver.

First layer (blue-sensitive emulsion layer):

| | |
|---|---|
| Silver chlorobromide emulsion | 0.27 |
| (crystal form: cube, average grain size: 0.79 μm, | |
| bromide content: 0.3 mole %) | |
| Gelatin | 1.22 |
| Yellow coupler (ExY) | 0.79 |
| Color image stabilizer (Cpd-1) | 0.08 |
| Color image stabilizer (Cpd-2) | 0.04 |
| Color image stabilizer (Cpd-3) | 0.08 |
| Color image stabilizer (Cpd-5) | 0.01 |
| Solvent (Solv-1) | 0.13 |
| Solvent (Solv-5) | 0.13 |

Second layer (color stain inhibiting layer):

| | |
|---|---|
| Gelatin | 0.90 |
| Color stain inhibitor (Cpd-4) | 0.08 |
| Solvent (Solv-1) | 0.10 |
| Solvent (Solv-2) | 0.15 |
| Solvent (Solv-3) | 0.12 |
| Color image stabilizer (Cpd-7) | 0.12 |
| Solvent (Solv-8) | 0.03 |

Third layer (green-sensitive emulsion layer):

| | |
|---|---|
| Silver chlorobromide emulsion | 0.13 |
| (crystal form: cube, average grain size: | |
| 0.79 μm, bromide content: 0.3 mole %) | |
| Gelatin | 1.45 |
| Magenta coupler (ExM) | 0.16 |
| Ultraviolet absorbent (UV-2) | 0.16 |
| Color image stabilizer (Cpd-2) | 0.03 |
| Color image stabilizer (Cpd-4) | 0.03 |
| Color image stabilizer (Cpd-5) | 0.10 |
| Color image stabilizer (Cpd-6) | 0.01 |
| Color image stabilizer (Cpd-7) | 0.08 |
| Color image stabilizer (Cpd-8) | 0.01 |
| Color image stabilizer (Cpd-10) | 0.02 |
| Color image stabilizer (Cpd-16) | 0.02 |
| Solvent (Solv-3) | 0.13 |
| Solvent (Solv-4) | 0.39 |
| Solvent (Solv-6) | 0.26 |

Fourth layer (color stain inhibiting layer):

| | |
|---|---|
| Gelatin | 0.68 |
| Color stain inhibitor (Cpd-4) | 0.06 |
| Solvent (Solv-1) | 0.07 |
| Solvent (Solv-2) | 0.11 |
| Solvent (Solv-3) | 0.09 |
| Color image stabilizer (Cpd-7) | 0.09 |
| Solvent (Solv-8) | 0.02 |

Fifth layer (red-sensitive emulsion layer):

| | |
|---|---|
| Silver chlorobromide emulsion | 0.18 |
| (crystal form: cube, average grain size: | |
| 0.43 μm, bromide content: 0.8 mole %) | |
| Gelatin | 0.80 |
| Cyan coupler (ExC) | 0.33 |
| Ultraviolet absorbent (UV-2) | 0.18 |
| Color image stabilizer (Cpd-1) | 0.33 |
| Color image stabilizer (Cpd-2) | 0.03 |
| Color image stabilizer (Cpd-6) | 0.01 |
| Color image stabilizer (Cpd-8) | 0.01 |
| Color image stabilizer (Cpd-9) | 0.02 |
| Color image stabilizer (Cpd-10) | 0.01 |
| Color image stabilizer (Cpd-15) | 0.04 |
| Solvent (Solv-1) | 0.01 |
| Solvent (Solv-7) | 0.22 |

Sixth layer (ultraviolet absorbing layer):

| | |
|---|---|
| Gelatin | 0.48 |
| Ultraviolet absorbent (UV-1) | 0.38 |
| Color image stabilizer (Cpd-5) | 0.01 |
| Color image stabilizer (Cpd-7) | 0.05 |
| Solvent (Solv-10) | 0.03 |
| Solvent (Solv-9) | 0.03 |
| Stabilizer (Cpd-14) | 0.03 |

Seventh layer (protective layer):

| | |
|---|---|
| Gelatin | 0.90 |
| Acryl-modified polyvinyl alcohol | 0.05 |
| (modification degree: 17%) | |
| Liquid paraffin | 0.02 |
| Color image stabilizer (Cpd-11) | 0.01 |

The structural formulae of the compounds used herein are illustrated below:

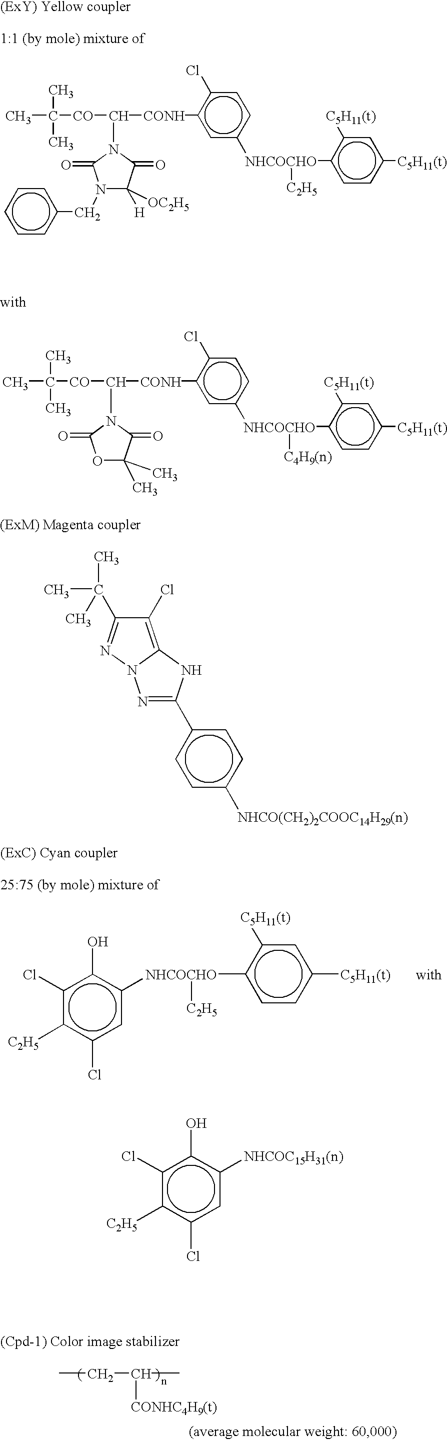

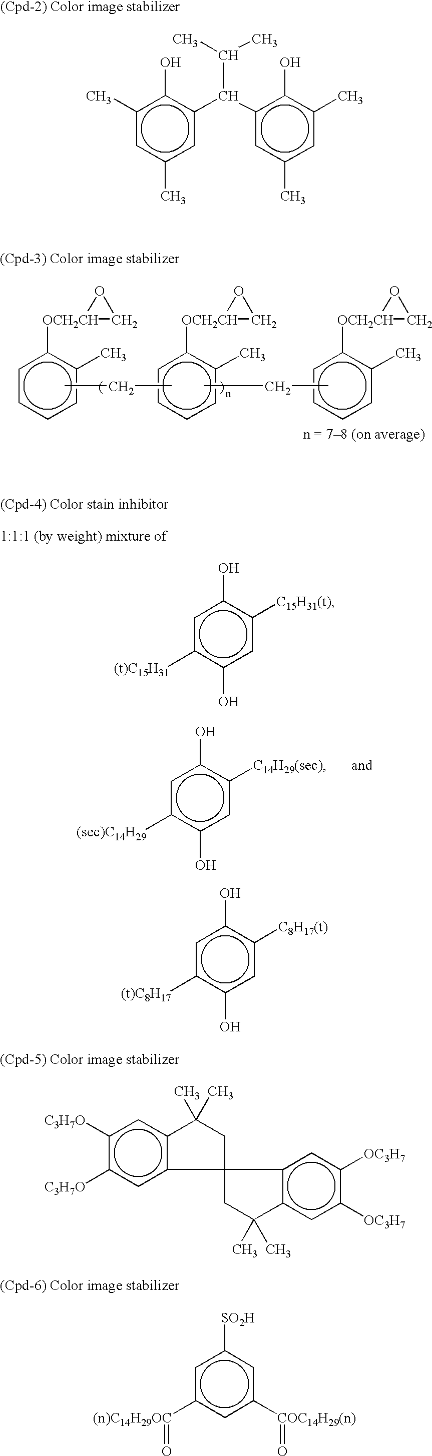

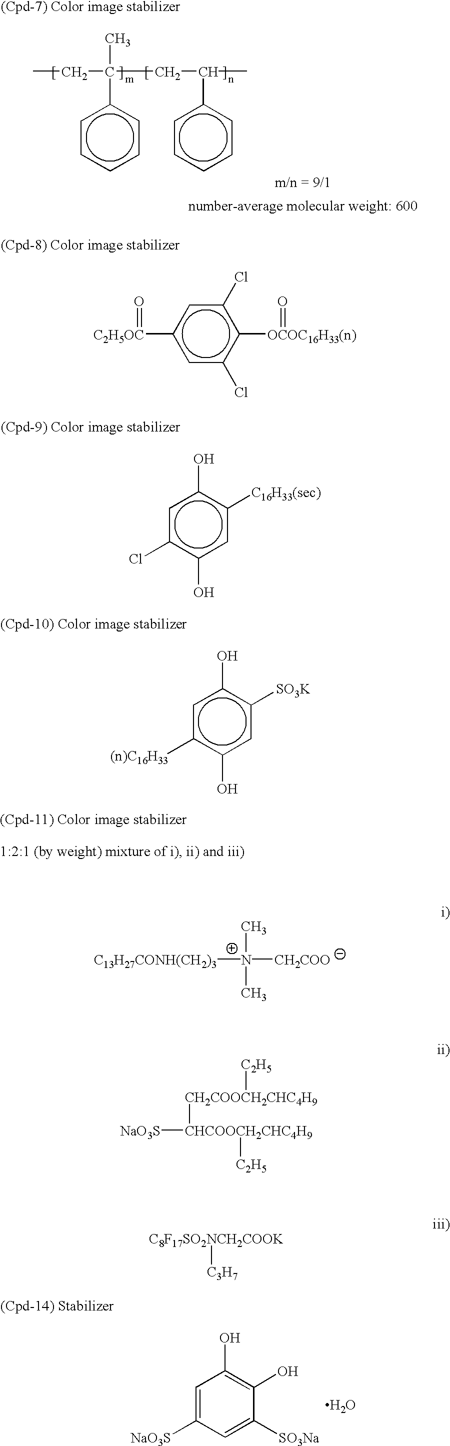

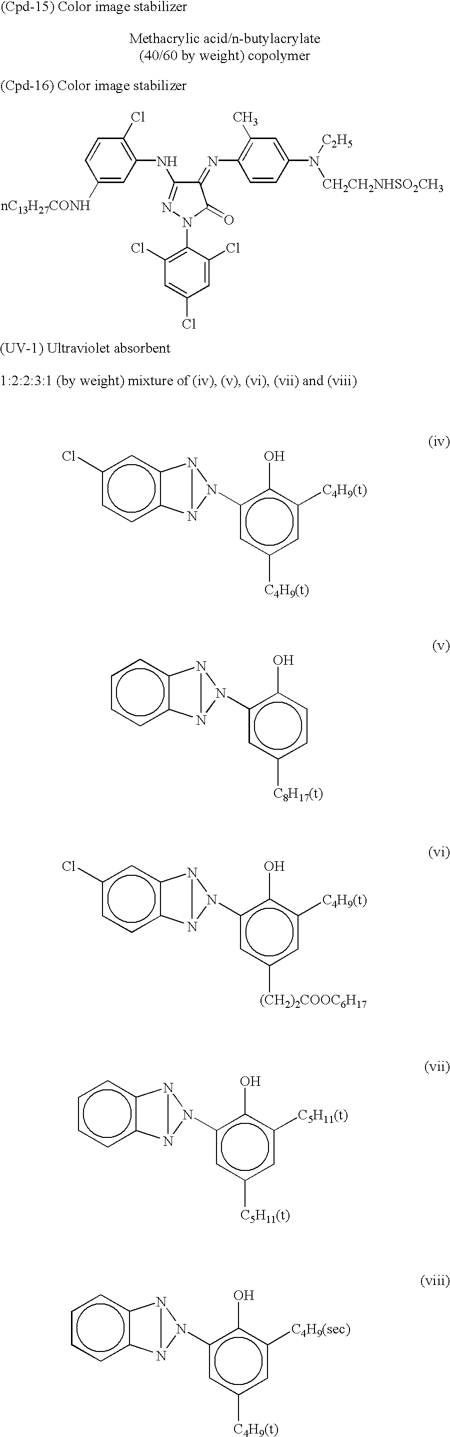

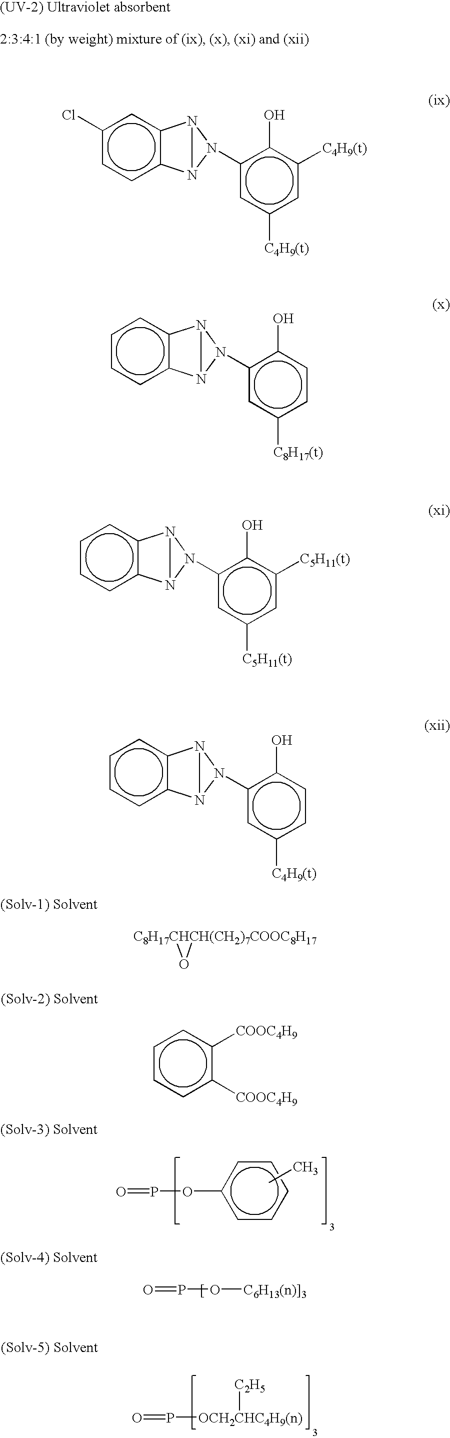

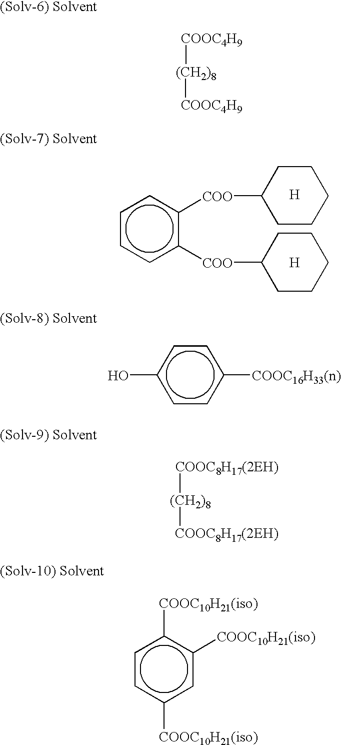

In preparing a coating solution, water was added to the foregoing compositions so that, when the curtain of freely falling coating solution was formed, the flow rate thereof per unit length in curtain breadth (abbreviated as “coating flow rate” or “q” hereinafter) was 2.5, 4, 5 or 6 cc/cm/sec without changing the coverage rate of each layer composition; and further, sodium polystyrenesulfonate as a thickener was added so that the viscosity of the lowest constituent layer was 20 cp (at the shearing speed of 10 l/sec) and the average viscosity of the other constituent layers was 50 cp (at the shearing speed of 10 l/sec).

In the curtain coating, the distance between the lip part of a slide hopper and the impinging position of the curtain was maintained at 100 mm, and the angle formed by the web with the horizontal line at the impinging position 6 was set at 60 degrees.

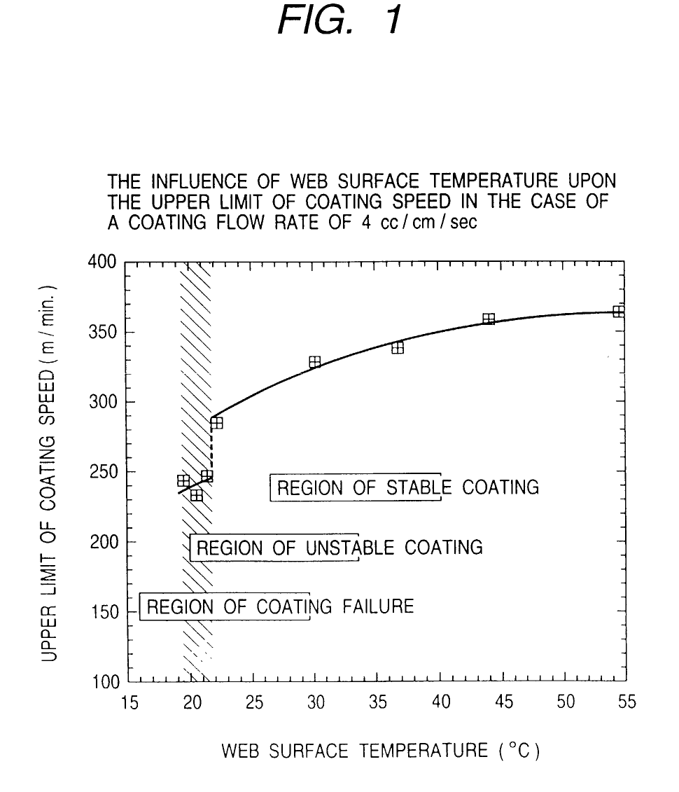

Changes in upper limit of coating speed were examined by carrying out the curtain coating under various web surface temperatures (The value of a surface temperature which the web had on the backup roller was adopted herein as the web surface temperature), and the results obtained are shown in Table 1. Further, the results obtained in the cases where the coating flow rate of 4 cc/cm/sec was chosen are illustrated in FIG. 1. As can be seen from FIG. 1, the upper limit of coating speed was greatly increased when the web surface temperature was adjusted to 22° C. or above; as a result, the prevention of uneven coating became possible to ensure stable coating. Moreover, it can be seen from Table 1 that the adjustment of the web surface temperature to 30° C. or above (Examples 1 to 8) was preferable.

TABLE 1

| | Web | | Upper limit | |
|---|---|---|---|---|
| | surface | Coating | of coating | Result |
| | temp. | flow rate | speed | (generation of |
| | (° C.) | (cc/cm/sec) | (m/min) | uneven coating) |
| Comparative | 18 | 4 | coating | considerable |
| Example 1 | | | failure | |
| Comparative | 19.5 | 4 | 240 | appreciable |
| Example 2 | | | | |
| Comparative | 20.5 | 4 | 233 | appreciable |
| Example 3 | | | | |
| Comparative | 21.5 | 2.5 | 245 | appreciable |
| Example 4 | | | | |
| Comparative | 21.5 | 4 | 240 | appreciable |
| Example 5 | | | | |
| Comparative | 21.5 | 5 | 243 | appreciable |
| Example 6 | | | | |
| Comparative | 21.5 | 6 | 245 | appreciable |
| Example 7 | | | | |
| Example 1 | 22 | 2.5 | 290 | not observed |
| Example 2 | 22 | 4 | 280 | not observed |
| Example 3 | 22 | 5 | 285 | not observed |
| Example 4 | 22 | 6 | 290 | not observed |
| Example 5 | 30 | 4 | 325 | not observed |
| Example 6 | 37 | 4 | 330 | not observed |
| Example 7 | 45 | 4 | 340 | not observed |
| Example 8 | 55 | 4 | 345 | not observed |

Another coating solution was prepared using the same compositions as described above, except that the viscosity of the lowest layer was adjusted to 90 cp (at the shearing speed of 10 l/sec), and coated in the same manners as described above. The results shown as Examples 9 to 11 in Table 2 demonstrate that similar results were obtained even when the viscosity of the lowest layer was raised.

TABLE 2

| | Web | | Upper limit | |
|---|---|---|---|---|
| | surface | Coating | of coating | Result |
| | temp. | flow rate | speed | (generation of |
| | (° C.) | (cc/cm/sec) | (m/min) | uneven coating) |
| Comparative | 18 | 4 | coating | considerable |
| Example 8 | | | failure | |
| Comparative | 20 | 4 | 215 | appreciable |
| Example 9 | | | | |
| Example 9 | 22 | 4 | 255 | not observed |
| Example 10 | 30 | 4 | 295 | not observed |
| Example 11 | 37 | 4 | 310 | not observed |

In cases where the aforementioned coating solutions were coated as applying electrostatic charge to the web so that the web surface potential was adjusted to 0.4 KV or 0.7 KV, as can be seen from Table 3, the upper limit of coating speed was further increased, particularly in Examples 12 to 17.

TABLE 3

| | | | | Upper | |
|---|---|---|---|---|---|
| | | | | limit | |
| | Web surface | | Coating | of | |
| | | Poten- | flow | coating | Result |
| | Temp. | tial | rate (cc/ | speed | (generation of |
| | (° C.) | (KV) | cm/sec) | (m/min) | uneven coating) |
| Comparative | 18 | 0.4 | 4 | coating | considerable |
| Example 10 | | | | failure | |
| Comparative | 19.5 | 0.4 | 4 | 320 | appreciable |
| Example 11 | | | | | |
| Comparative | 20.5 | 0.4 | 4 | 310 | appreciable |
| Example 12 | | | | | |
| Comparative | 21.5 | 0.4 | 4 | 325 | appreciable |
| Example 13 | | | | | |
| Comparative | 21.5 | 0.7 | 4 | 375 | appreciable |
| Example 14 | | | | | |
| Example 12 | 22 | 0.4 | 4 | 390 | not observed |
| Example 13 | 30 | 0.4 | 4 | 425 | not observed |
| Example 14 | 30 | 0.7 | 4 | 440 | not observed |
| Comparative | 30 | 1.0 | 4 | 450 | appreciable |
| Example 15 | | | | | |
| Example 15 | 37 | 0.4 | 4 | 450 | not observed |
| Example 16 | 45 | 0.4 | 4 | 455 | not observed |
| Example 17 | 55 | 0.4 | 4 | 460 | not observed |

### EXAMPLES 18 TO 23 AND COMPARATIVE EXAMPLES 16 TO 18

By performing a curtain coating operation under the conditions described below, the constituent layers having the compositions described below were coated simultaneously on a web of cellulose triacetate film provided with a subbing layer, or those constituent layers were divided into two groups and these two groups were subjected separately to the curtain coating on the aforesaid web, thereby preparing samples of multilayer color photosensitive material.

The composition of each constituent layer is described below. When the ingredient set forth is a silver halide emulsion or colloidal silver, the figure on the right side represents the coverage based on silver. When the ingredient set forth is a coupler, an additive or gelatin, the figure on the right side designates the coverage (g/m²) of the ingredient. When the ingredient set forth is a sensitizing dye, the figure on the right side designates the content by mole per mole of silver halide present in the same layer.

First layer (antihalation layer)

| | |
|---|---|
| Black colloidal silver | 0.2 |
| Gelatin | 1.3 |
| Colored coupler C-1 | 0.06 |
| Ultraviolet absorbent UV-1 | 0.1 |
| Ultraviolet absorbent UV-2 | 0.2 |
| Dispersing oil Oil-1 | 0.01 |
| Dispersing oil Oil-2 | 0.01 |

Second layer (interlayer)

| | |
|---|---|
| Fine-grain silver bromide | 0.15 |
| (average grain size: 0.07μ) | |
| Gelatin | 1.0 |
| Colored coupler C-2 | 0.02 |
| Dispersing oil Oil-1 | 0.1 |

Third layer (first red-sensitive emulsion layer)

| | |
|---|---|
| Silver iodobromide emulsion | 0.4 |
| (iodide content: 2 mole %, average grain size: 0.3μ) | |
| Gelatin | 0.6 |
| Sensitizing dye I | 1.0 × 10⁻⁴ |
| Sensitizing dye II | 3.0 × 10⁻⁴ |
| Sensitizing dye III | 1.0 × 10⁻⁵ |
| Coupler C-3 | 0.06 |
| Coupler C-4 | 0.06 |
| Coupler C-8 | 0.04 |
| Coupler C-2 | 0.03 |
| Dispersing oil Oil-1 | 0.03 |
| Dispersing oil Oil-3 | 0.012 |

Fourth layer (second red-sensitive emulsion layer)

| | |
|---|---|
| Silver iodobromide emulsion | 0.7 |
| (iodide content: 5 mole %, average grain size: 0.5μ) | |
| Sensitizing dye I | 1.0 × 10⁻⁴ |
| Sensitizing dye II | 3.0 × 10⁻⁴ |
| Sensitizing dye III | 1.0 × 10⁻⁵ |
| Coupler C-3 | 0.24 |
| Coupler C-4 | 0.24 |
| Coupler C-8 | 0.04 |
| Coupler C-2 | 0.04 |
| Dispersing oil Oil-1 | 0.15 |
| Dispersing oil Oil-3 | 0.02 |

Fifth layer (third red-sensitive emulsion layer)

| | |
|---|---|
| Silver iodobromide emulsion | 1.0 |
| (iodide content: 10 mole %, average grain size: 0.7μ) | |
| Gelatin | 1.0 |
| Sensitizing dye I | 1.0 × 10⁻⁴ |
| Sensitizing dye II | 3.0 × 10⁻⁴ |
| Sensitizing dye III | 1.0 × 10⁻⁵ |
| Coupler C-6 | 0.05 |
| Coupler C-7 | 0.10 |
| Dispersing oil Oil-1 | 0.01 |
| Dispersing oil Oil-2 | 0.05 |

Sixth layer (interlayer)

| | |
|---|---|
| Gelatin | 1.0 |
| Compound Cpd-A | 0.03 |
| Dispersing oil Oil-1 | 0.05 |

Seventh layer (first green-sensitive emulsion layer)

| | |
|---|---|
| Silver iodobromide emulsion | 0.30 |
| (iodide content: 4 mole %, average grain size: 0.3μ) | |
| Sensitizing dye IV | 5.0 × 10⁻⁴ |
| Sensitizing dye VI | 0.3 × 10⁻⁴ |
| Sensitizing dye V | 2.0 × 10⁻⁴ |
| Gelatin | 1.0 |
| Coupler C-9 | 0.2 |
| Coupler C-5 | 0.03 |
| Coupler C-1 | 0.03 |
| Dispersing oil Oil-1 | 0.5 |

Eighth layer (second green-sensitive emulsion layer)

| | |
|---|---|
| Silver iodobromide emulsion | 0.4 |
| (iodide content: 5 mole %, average grain size: 0.5μ) | |
| Sensitizing dye IV | 5.0 × 10⁻⁴ |
| Sensitizing dye V | 2.0 × 10⁻⁴ |
| Sensitizing dye VI | 0.3 × 10⁻⁴ |
| Coupler C-9 | 0.25 |
| Coupler C-1 | 0.03 |
| Coupler C-10 | 0.015 |
| Coupler C-5 | 0.01 |
| Dispersing oil Oil-1 | 0.2 |

Ninth layer (third green-sensitive emulsion layer)

| | |
|---|---|
| Silver iodobromide emulsion | 0.85 |
| (iodide content: 6 mole %, average grain size: 0.7μ) | |
| Gelatin | 1.0 |
| Sensitizing dye VII | 3.5 × 10⁻⁴ |
| Sensitizing dye VIII | 1.4 × 10⁻⁴ |
| Coupler C-1l | 0.01 |
| Coupler C-12 | 0.03 |
| Coupler C-13 | 0.20 |
| Coupler C-1 | 0.02 |
| Coupler C-15 | 0.02 |
| Dispersing oil Oil-1 | 0.20 |
| Dispersing oil Oil-2 | 0.05 |

Tenth layer (yellow filter layer)

| | |
|---|---|
| Gelatin | 1.2 |
| Yellow colloidal silver | 0.08 |
| Compound Cpd-B | 0.1 |
| Dispersing oil Oil-1 | 0.3 |

Eleventh layer (first blue-sensitive emulsion layer)

| | |
|---|---|
| Monodisperse silver iodobromide emulsion | 0.4 |
| (iodide content: 4 mole %, average grain size: 0.3μ) | |
| Gelatin | 1.0 |
| Sensitizing dye IX | 2.0 × 10⁻⁴ |
| Coupler C-14 | 0.9 |
| Coupler C-5 | 0.07 |
| Dispersing oil Oil-1 | 0.2 |

Twelfth layer (second blue-sensitive emulsion layer)

| | |
|---|---|
| Silver iodobromide emulsion | 0.5 |
| (iodide content: 10 mole %, average grain size: 1.5μ) | |
| Gelatin | 0.6 |
| Sensitizing dye IX | 1.0 × 10⁻⁴ |
| Coupler C-14 | 0.25 |
| Dispersing oil Oil | 0.07 |

Thirteenth layer (first protective layer)

| | |
|---|---|
| Gelatin | 0.8 |
| Ultraviolet absorbent V-1 | 0.1 |
| Ultraviolet absorbent V-2 | 0.2 |
| Dispersing oil Oil-1 | 0.01 |
| Dispersing oil Oil-2 | 0.01 |

Fourteenth layer (second protective layer)

| | |
|---|---|
| Fine-grain silver bromide | 0.5 |
| (average grain size: 0.07μ) | |
| Gelatin | 0.45 |
| Polymethylmethacrylate particles | 0.2 |
| (diameter: 1.5μ) | |
| Hardener H-1 | 0.4 |
| Formaldehyde scavenger S-1 | 0.5 |
| Formaldehyde scavenger S-2 | 0.5 |

In addition to the above ingredients, a gelatin hardener, gelatin antiseptic and antimold and a surfactant were added to all layers.

The structural formulae of the ultraviolet absorbents, the dispersing oils, the couplers and the sensitizing dyes contained in the foregoing compositions are illustrated below:

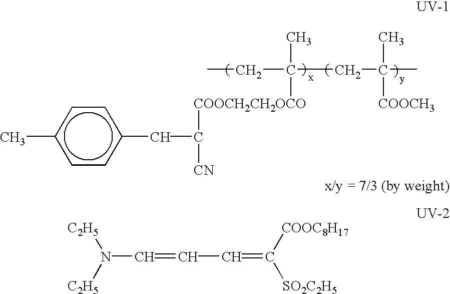

Oil-1 tricresyl phosphate

Oil-2 dibutyl phthalate

Oil-3 bis(2-ethylhexyl) phthalate

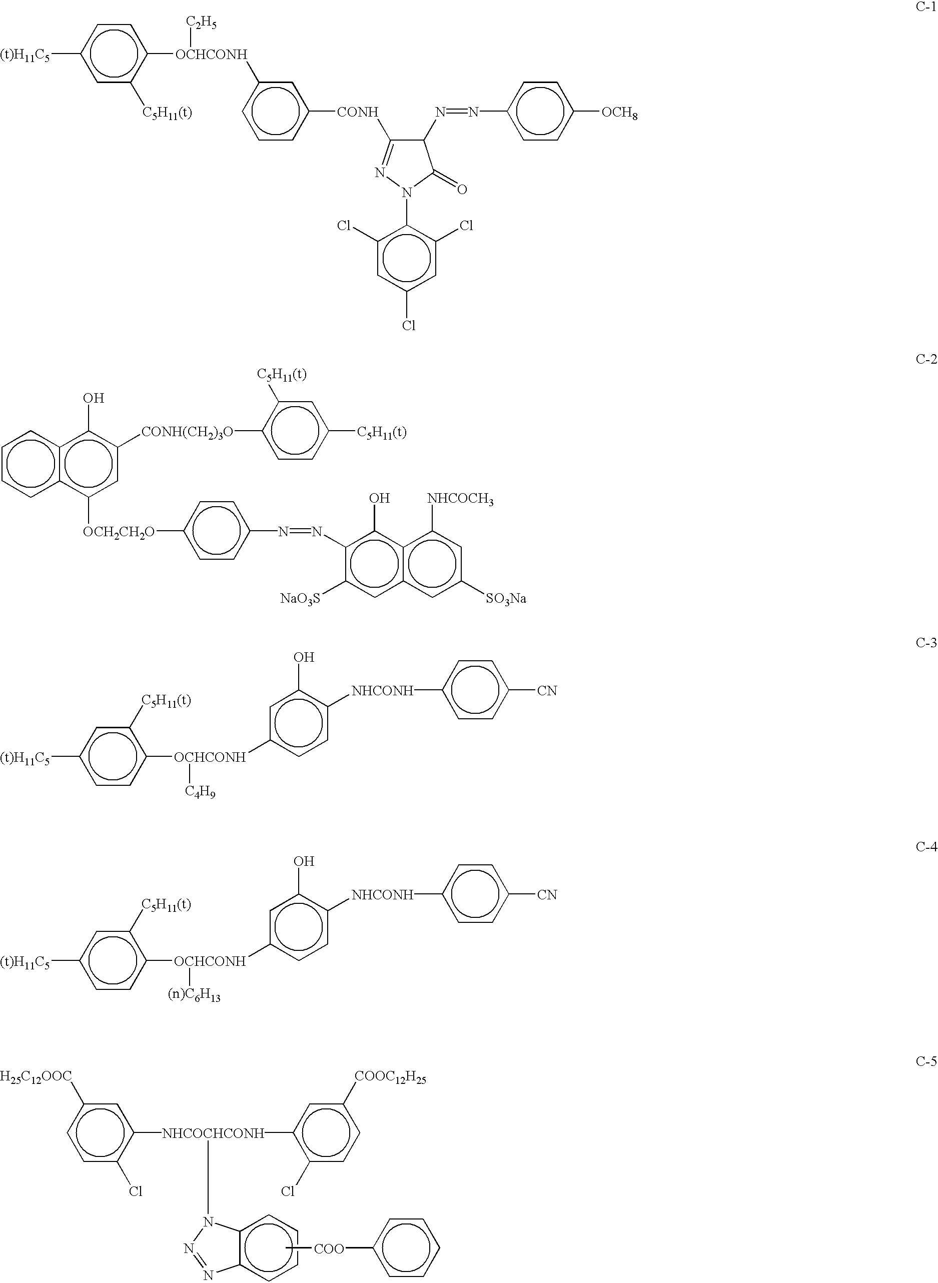

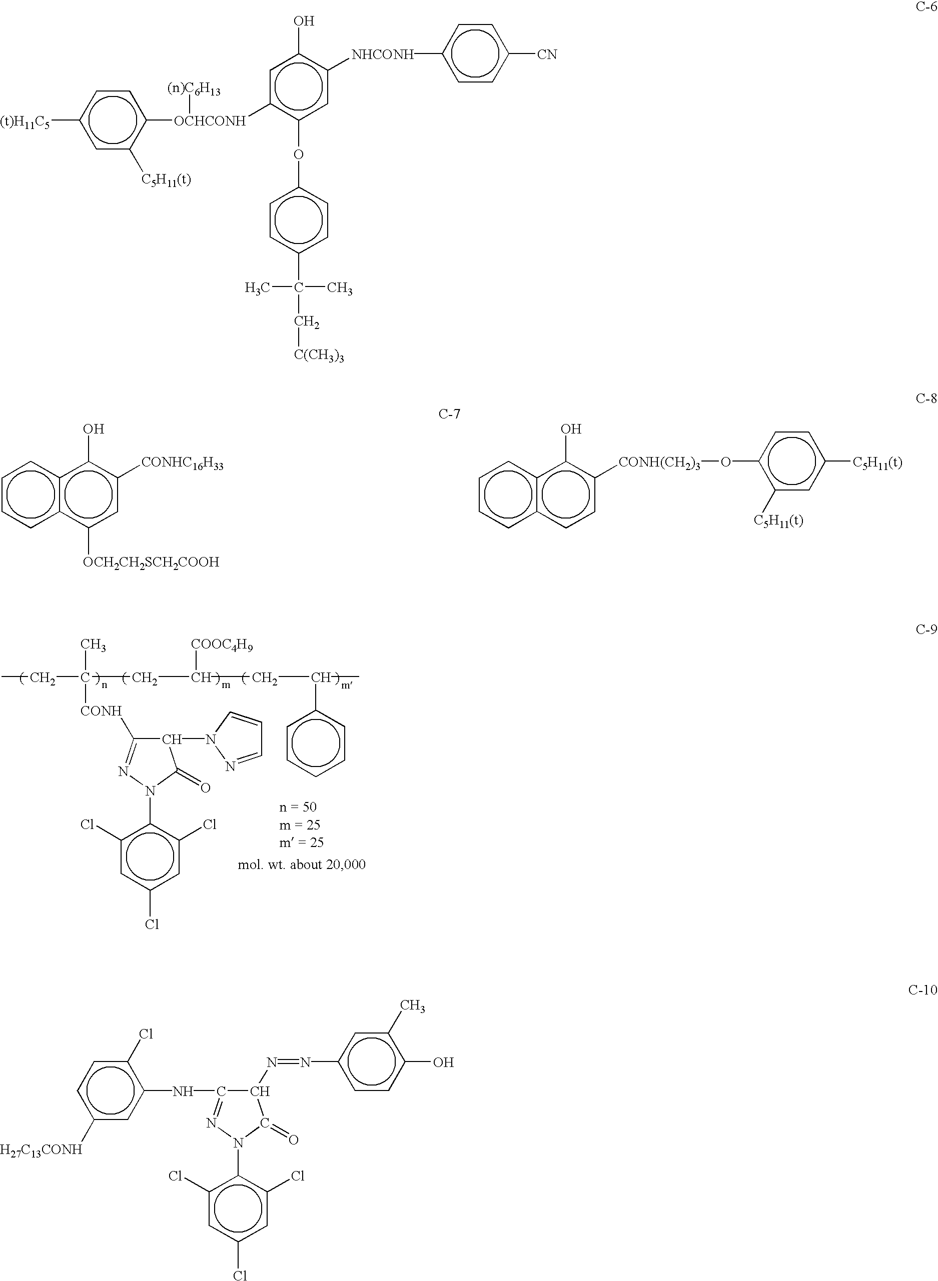

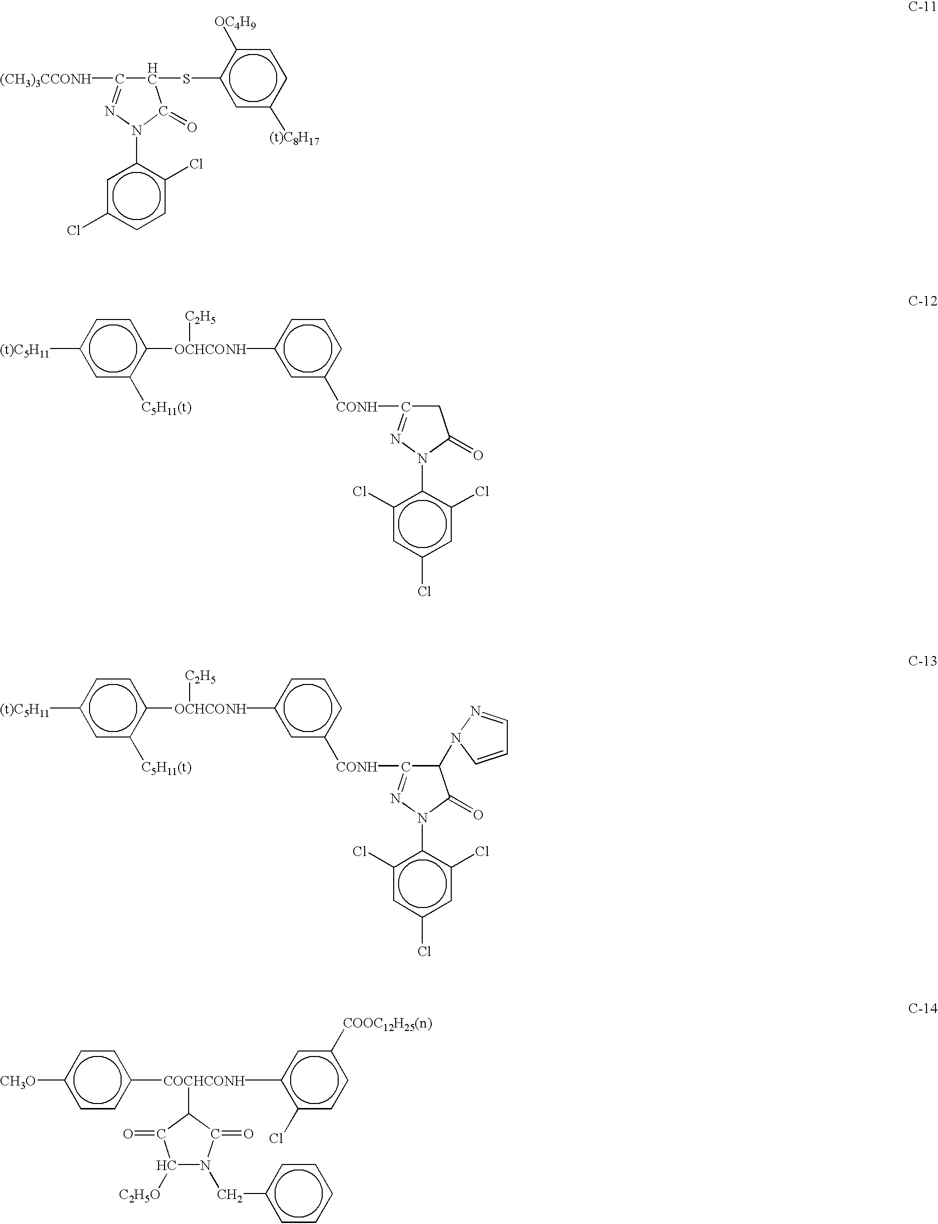

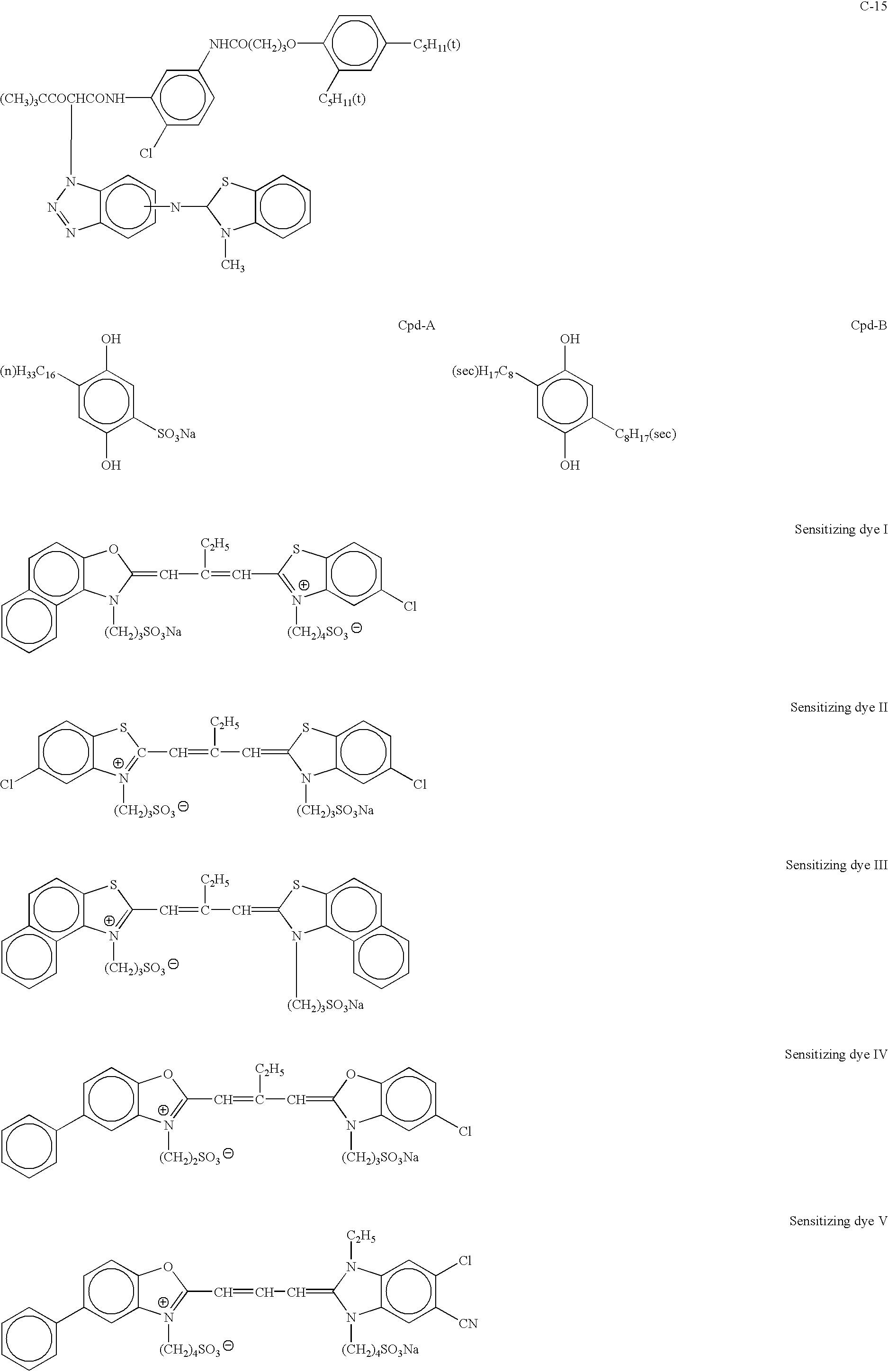

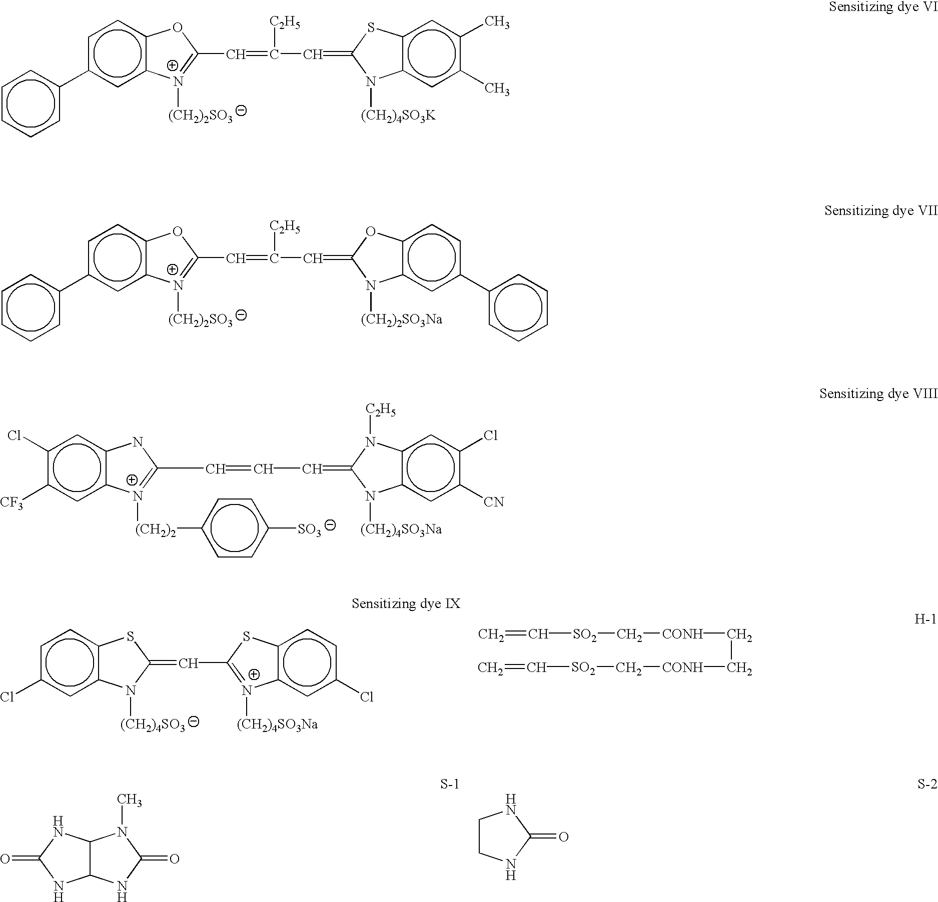

In a case where all the constituent layers were coated simultaneously, the viscosity of the lowest layer was adjusted to 30 cp (at a shearing speed of 10 l/sec) and the average viscosity of the other constituent layers was adjusted to 70 cp (at a shearing speed of 10 l/sec). Further, water was added to the foregoing compositions so that, when the curtain of freely falling coating solution was formed, the flow rate thereof per unit length in curtain breadth, q, was 7 or 10 cc/cm/sec without changing the coverage rate of each layer composition. The results of curtain coating performed under the aforesaid conditions are shown In Table 4.

In a case where two groups of constituent layers (from the first to the sixth layers formed one group and from the seventh to the fourteenth layers formed the other group) were subjected separately to the curtain coating, the viscosity of the lowest layer in each coating operation, namely the first layer or the seventh layer, was adjusted to 30 cp (at a shearing speed of 10 l/sec) and the average viscosity of the other constituent layers was adjusted to 70 cp (at a shearing speed of 10 l/sec). The results of curtain coating performed under those conditions are shown in Table 5.

In the curtain coating, the distance between the lip part of a slide hopper and the impinging position of the curtain was maintained at 200 mm, and the angle formed by the web with the horizontal line at the impinging position was set at 60 degrees.

Changes in upper limit of coating speed were examined by carrying out the curtain coating under various web surface temperatures (The term web surface temperature used herein refers to the value of a surface temperature which the web had on the backup roller), and the results obtained are shown in Tables 4 and 5. As can be seen from Tables 4 and 5, the upper limit of coating speed was improved in Examples 18 to 23.

TABLE 4
Cases where all constituent layers are coated simultaneously:

| | Web | | Upper limit | |
|---|---|---|---|---|
| | surface | Coating | of coating | Result |
| | temp. | flow rate | speed | (generation of |
| | (° C.) | (cc/cm/sec) | (m/min) | uneven coating) |
| Comparative | 20 | 7 | 240 | appreciable |
| Example 16 | | | | |
| Comparative | 20 | 10 | 230 | appreciable |
| Example 17 | | | | |
| Example 18 | 22 | 7 | 290 | not observed |
| Example 19 | 22 | 10 | 280 | not observed |
| Example 20 | 30 | 7 | 340 | not observed |
| Example 21 | 30 | 10 | 330 | not observed |

TABLE 5
Cases where two separate curtain-coating operations are performed
in each preparation of the photosensitive material:

| | | Web | | Upper limit | |
|---|---|---|---|---|---|
| | | surface | Coating | of coating | Result |
| | Coating operations | temp. | flow rate | speed | (generation of |
| | (layer structure) | (° C.) | (cc/cm/sec) | (m/min) | uneven coating) |
| Comparative | first (from 1st to 6th layer) | 20 | 4 | 250 | appreciable |
| Example 18 | second (from 7th to 14th layer) | | 4 | 255 | appreciable |
| Example 22 | first (from 1st to 6th layer) | 22 | 4 | 295 | not observed |
| | second (from 7th to 14th layer) | | 4 | 300 | not observed |
| Example 23 | first (from 1st to 6th layer) | 30 | 4 | 340 | not observed |
| | second (from 7th to 14th layer) | | 4 | 350 | not observed |

### EXAMPLES 24 TO 28 AND COMPARATIVE EXAMPLES 19 TO 21

The curtain coating operation in each example was carried out using the slide hopper type curtain coating apparatus equipped with a corona discharge treatment device as shown in FIG. 5 under the following conditions:

(1) Coating solution; The coating solution prepared by adding sodium polystyrenesulfonate to a 10% aqueous alkali-processed gelatin solution containing as an anionic surfactant the sodium salt of α-sulfosuccinic acid 2-ethylhexyl ester in a concentration of 0.1 weight % to adjust its viscosity to 60 cps at the shearing speed of 10/sec.

(2) Flow rate per unit breadth; 4 cc/cm·sec

(3) Height of curtain; 100 mm

(4) Coating speed; 200 m/sec

(5) Conditions for corona discharge treatment; Performing the corona discharge treatment just before the impingement of the curtain on the web and adjusting the surface potential of the web to 1,300 V on the coating side.

After coating over the web, the coated layer was examined by visual observation as to whether or not “air entrainment phenomenon had occurred therein.

The results obtained in examples and comparative examples are shown in Table 6.

TABLE 6

| | Relative speed of | Occurrence of air |
|---|---|---|
| | deflector | entrainment phenomenon |
| | to slide hopper | in coated layer |
| Example 24 | 20 mm/sec | No |
| Example 25 | 50 mm/sec | No |
| Example 26 | 100 mm/sec | No |
| Example 27 | 125 mm/sec | No |
| Example 28 | 350 mm/sec | No |
| Comparative | 10 mm/sec | Yes (intermittent) |
| Example 19 | | |
| Comparative | 375 mm/sec | Yes (intermittent) |
| Example 20 | | |
| Comparative | 500 mm/sec | Yes (intermittent) |
| Example 21 | | |

As can be seen from Table 6, the “air entrainment phenomenon” was not observed at all when the relative speed of the deflector to the slide hopper was within the range of 20 to 350 mm/sec, as demonstrated by the results of the cases where the coating operation was started by respectively adjusting the relative speed to the 5 different values selected from the aforesaid range.

On the other hand, as is apparent from the comparative examples, intermittent occurrence of “air entrainment phenomenon” was observed when the relative speed of the deflector to the slide hopper was adjusted to a value below 20 mm/sec, specifically 10 mm/sec, or a value above 350 mm/sec, specifically 375 or 500 mm/sec.

Moreover, only the cases where the relative speed was controlled so as to be from 20 mm/sec to 350 mm/sec, were successful in forming a uniform coated layer on the web from just after the start in the coating operation, although these results are not shown in Table 6.

Additionally, although in the examples described above the electrostatic potential was applied to the web surface by the corona discharge treatment just before the coating operation, other charging methods can be also adopted. For instance, the method as described in JP-A-63-4881, in which a DC voltage is applied to the backup roller on which the coating of the web is carried out, or the method as described in JP-A-61-161177, in which a potential generated by electrostatic induction is applied to the backup roller on which the coating of the web is carried out, was applicable to the present invention.

In accordance with the present curtain coating method, as mentioned above, the behavior of a curtain can be stabilized without accompanying the sagging phenomenon in a high flow rate range, specifically the range of 2.5 to 10 cc/cm/sec expressed in terms of the flowing-down rate of a coating solution per unit length in curtain breadth, and thereby a uniform coating which does not cause any uneven coating can be formed, and the upper limit of coating speed can be elevated.

Further, as illustrated above, the curtain coating method according to the present invention enables the start in the formation of uniform coating without attended by the air entrainment phenomenon” at the time of starting the coating operation. As a result of it, a loss during the production due to generation of defects is greatly reduced.

While the invention has been described in detail and with reference to specific embodiments thereof, it will be apparent to one skilled in the art that various changes and modifications can be made therein without departing from the spirit and scope thereof.

What is claimed is:

1. A curtain coating method for making a photographic light-sensitive material with at least one layer of photographic coating composition on a support comprising:
moving a web along a path through a coating zone;
forming a free-falling vertical curtain of coating composition, at a location closely spaced to said web; and
impinging said curtain on the surface of said web,
wherein said coating composition is controlled so that the flowing-down rate thereof per unit length in curtain breadth is from 2.5 to 10 cc/cm/sec, and said web surface is controlled so as to have a temperature between 22° C. and 55° C.

2. A coating method according to claim 1, wherein electrostatic charge is applied on the surface of said web before or during the coating step so that the web has a surface potential between 0.1 and 0.8 KV during the coating.

3. A curtain coating method for making a photographic light-sensitive material with at least one layer of photographic coating composition on a support comprising:
moving a web along a path though a coating zone mainly consisting of a coating hopper and a deflector;
forming a free-falling vertical curtain of coating composition from said coating hopper, at a location closely spaced to said web; and
impinging said curtain on the surface of said web,
wherein said coating is started under a condition that said surface to be coated bears electrostatic charge, and
at least either said coating hopper or said deflector is moved at a relative speed of from 20 to 350 mm/sec to retract said deflector through said curtain.

4. A coating method according to claim 2 or 3, wherein said electrostatic charge is applied by a corona discharge treatment before and during the coating process.

5. A coating method according to claim 1, 2, 3 or 4, wherein said curtain consists of a plurality of flowing layers of coating compositions to form a composite layer.

6. A coating method according to claim 5, wherein the number of said flowing layers is 13 or more.
